(19) United States
(12) Patent Application Publication
(10) Pub. No.: US 2019/0033792 A1
(43) Pub. Date: Jan. 31, 2019

(54) CASE AND TIMEPIECE

(71) Applicant: CASIO COMPUTER CO., LTD., Tokyo (JP)

(72) Inventors: Shouta NAGASAWA, Tokyo (JP); Junichi SATO, Tokyo (JP)

(73) Assignee: CASIO COMPUTER CO., LTD., Tokyo (JP)

(21) Appl. No.: 16/045,886

(22) Filed: Jul. 26, 2018

(30) Foreign Application Priority Data
Jul. 27, 2017 (JP) 2017-145328

(51) Int. Cl. G04B 37/22

(52) U.S. Cl. CPC G04B 37/225; G04B 37/22

(57) ABSTRACT

A case including a case body, and an exterior member which is arranged on an outer periphery of the case body in a manner to be deformable in a circumferential direction and which is provided with a separation section for separating at least a part of the case body in the circumferential direction.

### CROSS-REFERENCE TO RELATED APPLICATION

This application is based upon and claims the benefit of priority from the prior Japanese Patent Application No. 2017-145328, filed Jul. 27, 2017, the entire contents of which are incorporated herein by reference.

### BACKGROUND

### 1. Field of the Invention

The present invention relates to a case that is used for electronic devices such as wristwatches and a timepiece including the same.

### 2. Description of the Related Art

For example, a shield case for an electronic device is known which has a structure where side plates are provided around a top plate, fixed on a circuit board, and cover electronic components on the circuit board so as to shield the electronic components on the circuit board, as described in Japanese Patent Application Laid-Open (Kokai) Publication No. 2011-249689.

This type of shield case is structured such that, by the side plates having a plurality of slit sections provided over a range from the top plate to an end portion of each side of the side plates located on the opposite side of the top plate, the entire shield case is flexurally deformed by the plurality of slit sections when subjected to a shock due to a drop or the like to mitigate the shock.

However, in the case of this shield case, when the entire shield case is subjected to a shock due to a drop or the like and flexurally deformed by the plurality of slit sections provided on the side plates, stress due to the shock is concentrated on portions of the top plate corresponding to the plurality of slit portions, whereby the top plate is easily damaged.

### SUMMARY

In accordance with one embodiment, there is provided a case comprising: a case body; and an exterior member which is arranged on an outer periphery of the case body in a manner to be deformable in a circumferential direction and which is provided with a separation section for separating at least a part of the case body in the circumferential direction.

The above and further objects and novel features of the present invention will more fully appear from the following detailed description when the same is read in conjunction with the accompanying drawings. It is to be expressly understood, however, that the drawings are for the purpose of illustration only and are not intended as a definition of the limits of the invention.

### BRIEF DESCRIPTION OF THE DRAWINGS

FIG. 1 is a front view showing an embodiment where the present invention has been applied in a wristwatch;

FIG. 2 is an enlarged side view showing the wristwatch shown in FIG. 1 when viewed from the 3 o'clock side;

FIG. 3 is an enlarged sectional view taken along line A-A of the wristwatch shown in FIG. 1;

FIG. 4 is an exploded perspective view of the wristwatch shown in FIG. 1;

FIG. 5 is an enlarged perspective view showing a state where a switch section on the 3 o'clock side has been removed in the wristwatch shown in FIG. 2; and

FIG. 6 is an enlarged perspective view of the main section, which shows a separation section in an exterior member positioned on the 3 o'clock side of the wristwatch shown in FIG. 5.

### DETAILED DESCRIPTION OF THE PREFERRED EMBODIMENT

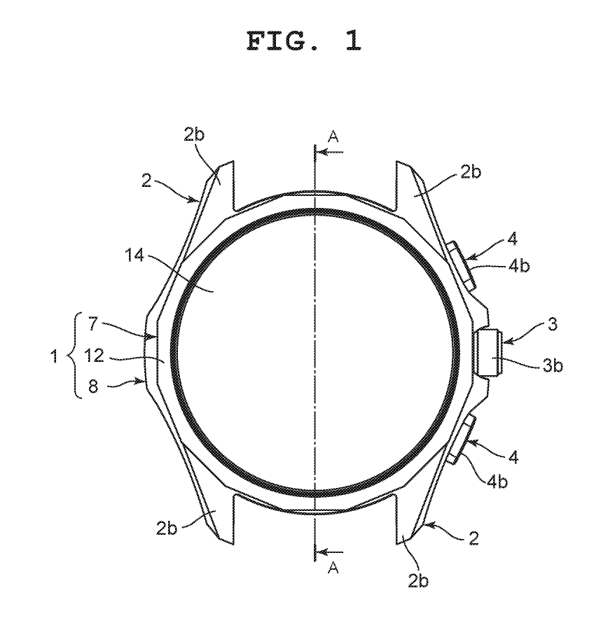

An embodiment has been applied in a wristwatch will hereinafter be described with reference to FIG. 1 to FIG. 6.

This wristwatch includes a wristwatch case 1, as shown in FIG. 1 to FIG. 3. On the 12 o'clock side and the 6 o'clock side of this wristwatch case 1, band attachment sections 2 are respectively provided. A switch section 3 such as a crown is provided on the 3 o'clock side of the wristwatch case 1, and push-button switches 4 are respectively provided on the 2 o'clock side and the 4 o'clock side of the wristwatch case 1.

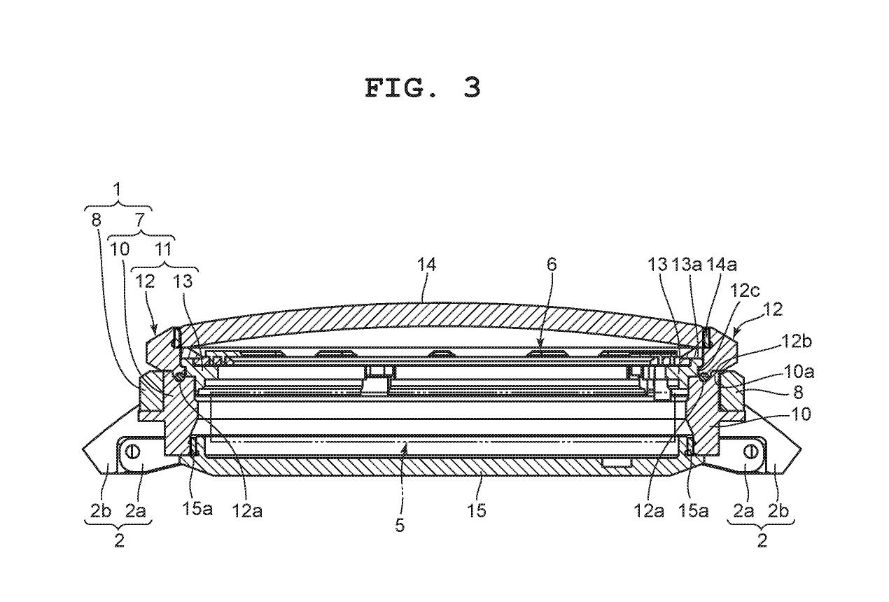

As shown in FIG. 3A, a timepiece module 5 is arranged inside this wristwatch case 3. This timepiece module 5 includes various types of components (all not shown) required for a timepiece function, such as a timepiece movement which indicates time by moving hands, a display section which electrophotographically displays information regarding time, date, or the like, and a circuit board which drives the display section. Above the timepiece module 5, a ring-shaped parting member 6 is also arranged.

On the other hand, this wristwatch case 1 includes a case body 7 and an exterior case 8 serving as an exterior member, as shown in FIG. 1 to FIG. 4. The case body 7 includes a first case section 10 and a second case section 11. The first case section 10 is formed in a substantially ring shape of hard synthetic resin or metal. The second case section 11 includes an outer case 12 and an inner case 13.

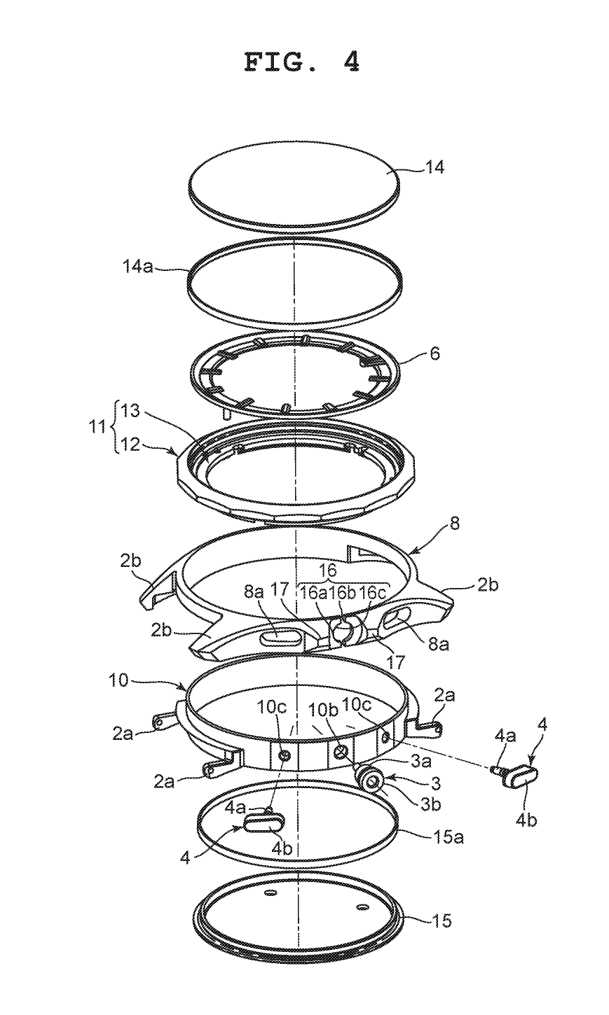

The outer case 12 in the second case section 11 is formed of hard synthetic resin or metal, as shown in FIG. 3 and FIG. 4. This outer case 12 has its outer diameter larger than the outer diameter of the first case section 10 and its inner diameter larger than the inner diameter of the first case section 10, and is arranged at the upper end of the first case section 10 via a waterproof packing 12a formed in a ring shape of a size smaller than the outer diameter of the first case section 10.

The outer case 12 is also formed such that an outer peripheral projection section 10a provided on the outer periphery at the upper end of the first case section 10 is fitted into a notch section 12b provided on the outer periphery of a lower portion of the outer case 12 when arranged at the upper end of the first case section 10, as shown in FIG. 3 and FIG. 4. As a result, the outer case 12 is structured such that its position in a radial direction is regulated when arranged at the upper end of the first case section 10.

Also, the inner case 13 in the second case section 11 is formed of hard synthetic resin or metal, like the outer case 12, as shown in FIG. 3 and FIG. 4. This inner case 13 is formed in a ring shape having its outer diameter equal to the inner diameter of the outer case 12 and its inner diameter smaller than the inner diameter of the first case section 10.

As a result, the inner case 13 is structured to be fitted into and attached to the inner periphery of an upper portion of the first case section 10 with it protruding into the first case section 10, as shown in FIG. 3 and FIG. 4. Also, the inner case 13 is formed such that its height protruding onto the upper end of the first case section 10 is half or less than the height of the outer case 12 corresponding thereto.

Moreover, the inner case 13 is structured to be inserted into the outer case 12 from thereabove and fitted into the inner periphery of the upper portion of the first case section 10 with the outer case 12 being arranged at the upper end of the first case section 10 via the waterproof packing 12a, as shown in FIG. 3 and FIG. 4. As a result, in the inner case 13, a locking section 13a provided on its inner peripheral surface presses an inner peripheral projection section 12c provided in a lower portion of the inner peripheral surface of the outer case 12 from above so as to fix the outer case 12 to the upper end of the first case section 10.

Also, as shown in FIG. 1 to FIG. 4, a timepiece glass 14 is attached to the upper opening of the case body 7 in this wristwatch case 1, i.e., the upper opening of the outer case 12 in the second case section 11, via a glass packing 14a. A rear cover 15 is attached to a lower portion of the case body 7 in this wristwatch case 1, i.e., a lower portion of the first case section 10 via a waterproof ring 15a.

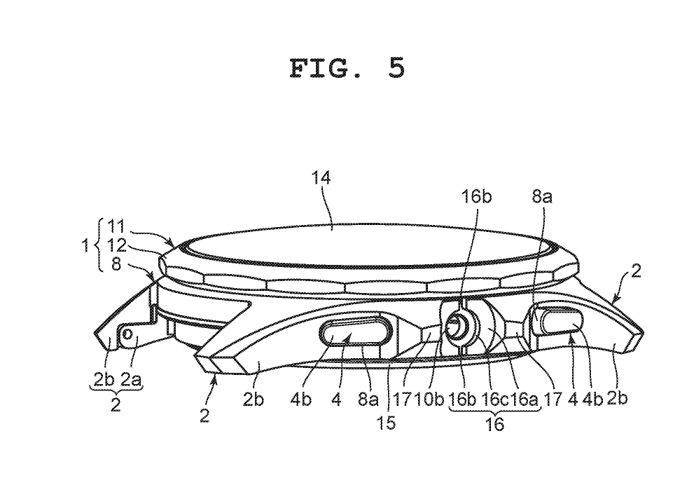

Also, on the 12 o'clock side and the 6 o'clock side of the outer peripheral surface of the first case section 10 in the case body 7, attachment projection sections 2a (band projection sections) in the band attachment section 2 in the wristwatch case 1 are respectively provided protruding outward, as shown in FIG. 3. On the 3 o'clock side of this first case section 10, a switch attachment hole 10b which an operation shaft 3a in the switch section 3 is inserted into and attached to is provided, as shown in FIG. 4 and FIG. 5. Further, on the 2 o'clock side and the 4 o'clock side of this first case section 10, button attachment holes 10c which a button shaft 4a in the button switch 4 are respectively inserted into and attached to are respectively provided.

The exterior case 8 is formed in a substantially ring shape of a high hardness material, e.g., ceramics such as zirconium oxide (ZrO₂) or aluminum oxide (Al₂O₃), as shown in FIG. 1 to FIG. 5. This exterior case 8 is formed to have its inner diameter substantially equal to the outer diameter of the first case section 10 in the case body 7 and its outer diameter substantially equal to the outer diameter of the outer case 12 in the second case section 11 in the case body 7. As a result, the outer case 8 is arranged to be deformable in its circumferential direction with respect to the first case section 10 with it covering the outer periphery of the first case section 10.

On the 12 o'clock side and the 6 o'clock side on the outer peripheral surface of this exterior case 8, cover projection sections 2b (cover sections) in the band attachment sections 2 in the wristwatch case 1 are respectively provided, as shown in FIG. 3. The cover projection section 2b of the exterior case 8 is formed to cover the attachment projection section 2a of the first case section 10 when the exterior case 8 is arranged on the outer periphery of the first case section 10. The cover projection section 2b is also formed such that, when it covers the attachment projection section 2a of the first case section 10, a gap is formed in the circumferential direction of the exterior case 8 between the inner surface of the cover projection section 2b and the outer surface of the attachment projection section 2a.

Also, this exterior case 8 has a separation section 16 for separating the exterior case 8 in the circumferential direction thereof provided at its portion corresponding to the 3 o'clock side of the first case section 10 on which the switch section 3 is provided, as shown in FIG. 4 to FIG. 6. This exterior case 8 also has a pair of protection projection sections 17 for protecting an operation head section 3b of the switch section 3 respectively provided to protrude in a mountain shape on both sides in the circumferential direction of the separation section 16.

The separation section 16 in this exterior case 8 includes a substantially circular recess section 16a provided on the outer peripheral surface of the exterior case 8, a slit 16b provided in this recess section 16a for separating the exterior case 8 in the circumferential direction thereof, and a switch insertion hole 16c provided in a central portion of the recess section 16a, as shown in FIG. 4 to FIG. 6.

Also, the recess section 16a in the separation section 16 has a diameter substantially equal to the length of the exterior case 8 in the direction perpendicular to the circumferential direction, i.e., the length of the first case section 10 in the height direction (the length in the vertical direction in FIG. 5) and is formed in a substantially circular mortar shape in a depressed state between the pair of protection projection sections 17, as shown in FIG. 4 to FIG. 6.

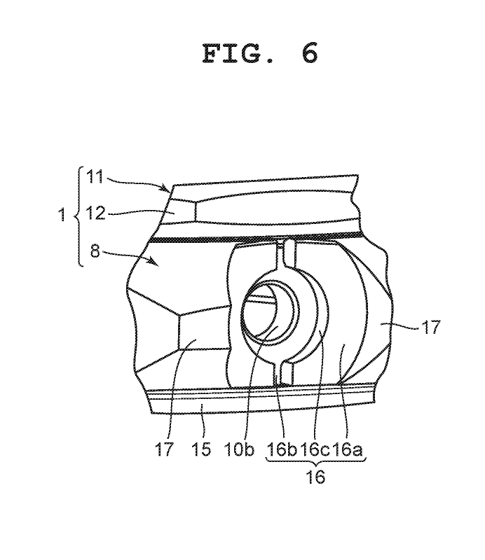

The slit 16b is provided over a range from the upper end to the lower end of the exterior case 8 through the central portion of the recess section 16a in the direction perpendicular to the circumferential direction of the exterior case 8, i.e., the height direction (the vertical direction in FIG. 5) of the first case section 10, as shown in FIG. 5 to FIG. 6. That is, the slit 16b is to make the exterior case 8 deformable in the circumferential direction of the exterior case 8 with the exterior case 8 being arranged on the outer periphery of the first case 19, and has a width in the circumferential direction smaller than the outer diameter of the operation shaft 3a in the switch section 3.

Also, the switch insertion hole 16c is a circular hole in which the columnar operation head section 3b of the switch section 3 is rotatably arranged, and is provided with it penetrating through the central portion of the recess section 16a, as shown in FIG. 4 to FIG. 6. Accordingly, the slit 16b is provided with it being divided into an upper side and a lower side of the switch insertion hole 16c.

This switch insertion hole 16c has its inner diameter slightly larger than the outer diameter of the operation head section 3b of the switch section 3, as shown in FIG. 4 to FIG. 6. Accordingly, when the operation head section 3b of the switch section 3 is arranged, a gap is formed between the outer peripheral surface of the operation head section 3b and the inner peripheral surface of the switch insertion hole 16c. Also, the switch insertion hole 16c is provided corresponding to the switch attachment hole 10b in the first case section 10 such that its central axis matches a central axis of the switch attachment hole 10b in the first case section 10.

As a result, the switch section 3 is structured such that the operation head section 3b is inserted into the switch insertion hole 16c in the exterior case 8 and exposed to the outside with the operation shaft 3a being inserted into and attached to the switch attachment hole 10b in the first case section 10, as shown in FIG. 4 to FIG. 6. The switch section 3 is also structured such that the operation head section 3b does not come in contact with the inner peripheral surface of the switch insertion hole 16c by the gap formed between the outer peripheral surface of the operation head section 3b and the inner peripheral surface of the switch insertion hole 16c even when the exterior case 8 is displaced in the circumferential direction thereof.

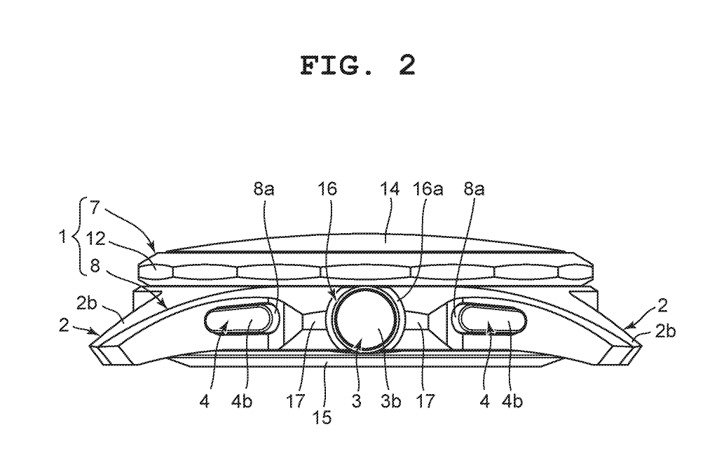

On the 2 o'clock side and the 4 o'clock side of this exterior case 8, button insertion holes 8a into which a button head section 4b in the push-button switch 4 has been inserted are respectively provided coaxially with the button attachment holes 10c in the first case section 10, as shown in FIG. 2 to FIG. 5. On the other hand, the button head section 4b in the push-button switch 4 is formed in a substantially rectangular shape which is long in the circumferential direction on the outer peripheral surface of the wristwatch case 1. Accordingly, the button insertion hole 8a is formed in a substantially rectangular shape which is slightly longer in the circumferential direction of the exterior case 8 than the button head section 4b in the push-button switch 4.

That is, this button insertion hole 8a is formed to have a gap having substantially the same dimension as the width of the slit 16b in the separation section 16 provided between itself and both ends of the button head section 4b in the circumferential direction of the exterior case 8 with the button head section 4b in the push-button switch 4 being arranged therein, as shown in FIG. 4 and FIG. 5. As a result, the push-button switch 4 is structured such that both ends of the button head section 4b do not come in contact with the inner surface of the button insertion hole 8a even when the exterior case 8 is displaced in the circumferential direction thereof with the button head section 4b being arranged in the button insertion hole 8a in the exterior case 8.

Next, the mechanism of this wristwatch is described.

In the assembly of the wristwatch case 1, the exterior case 8 is first attached to the outer periphery of the first case section 10 in the case body 7. Here, the slit 16b and the switch insertion hole 16c in the separation section 16 are provided on the 3 o'clock side of the exterior case 8, whereby the exterior case 8 can be pushed out in the circumferential direction thereof. Accordingly, the exterior case 8 can be smoothly and favorably fitted into the outer periphery of the first case section 10 from above the first case section 10.

Here, the cover projection sections 2b in the exterior case 8 are respectively made to correspond to the attachment projection sections 2a on the 12 o'clock side and the 6 o'clock side of the first case section 10 so as to cover the attachment projection sections 2a in the first case section 10. Here, a gap having substantially the same dimension as the width of the slit 16b in the separation section 16 in the exterior case 8 is formed in the circumferential direction of the exterior case 8 between the inner surface of the cover projection section 2b of the exterior case 8 and the outer surface of the attachment projection section 2a of the first case section 10. As a result, the band attachment section 2 in the wristwatch case 1 is formed.

Also, here, the switch insertion hole 16c in the separation section 16 in the exterior case 8 is positioned coaxially with the switch attachment hole 10b in the first case section 10 and the button insertion hole 8a in the exterior case 8 is positioned coaxially with the button attachment hole 10c in the first case section 10. As a result, the exterior case 8 is attached with it being deformable in the circumferential direction thereof on the outer periphery of the first case section 10.

The second case section 11 is attached to the upper end of the first case section 10 so as to assemble the case body 7. Here, the waterproof packing 12a is first arranged at the upper end of the first case section 10 and the outer case 12 in the second case section 11 is arranged at the upper end of the first case section 10. Here, the notch section 12b provided on the outer periphery of the lower portion of the outer case 12 is fitted into the outer peripheral projection section 10a provided on the outer periphery at the upper end of the first case section 10. As a result, the outer case 12 is arranged at the upper end of the first case section 10 with the position in the radial direction regulated.

In this state, the inner case 13 in the second case section 11 is inserted into the outer case 12 from thereabove, and is fitted into the inner periphery of the upper portion of the first case section 10. Here, the locking section 13a provided on the inner peripheral surface of the inner case 13 presses the inner peripheral projection section 12c provided in the lower portion of the inner peripheral surface of the outer case 12 from above. Accordingly, the outer case 12 is fixed with it being pressed against the upper end of the first case section 10 via the waterproof packing 12a. As a result, the second case section 11 is assembled on the first case section 10, whereby the wristwatch case 1 is assembled.

When the timepiece glass 14 is to be attached to this wristwatch case 1, the ring-like parting member 6 is first inserted into the outer case 12 from thereabove, and arranged on the inner case 13. In this state, the timepiece glass 14, together with the glass packing 14a, is fitted into and attached to an upper portion of the outer case 12. Then, the timepiece module 5 is arranged within the first case section 10 in the case body 7 from below the wristwatch case 1.

In this state, the switch section 3 is attached to the 3 o'clock side of the wristwatch case 1 and the push-button switches 4 are respectively attached to the 2 o'clock side and the 4 o'clock side thereof. That is, when the switch section 3 is to be attached, the operation shaft 3a is inserted into and attached to the switch attachment hole 10b in the first case section 10 from the switch insertion hole 16c in the separation section 16 in the exterior case 8 while the operation head section 3b is inserted into the switch insertion hole 16c in the separation section 16 in the exterior case 8 and exposed to the outside of the wristwatch case 1.

Here, a gap having substantially the same dimension as the width in the circumferential direction of the exterior case 8 of the slit 16b in the separation section 16 in the exterior case 8 is formed between the inner peripheral surface of the switch insertion hole 16c in the separation section 16 in the exterior case 8 and the outer peripheral surface of the operation head section 3b of the switch section 3. As a result, the switch section 3 is attached to the 3 o'clock side of the wristwatch case 1.

Also, when the push-button switch 4 is to be attached to the wristwatch case 1, the button shaft 4a is inserted into and attached to the button attachment hole 10c in the first case section 10 from the button insertion hole 8a in the exterior case 8 and the button head section 4b is inserted into the button insertion hole 8a in the exterior case 8 and exposed to the outside of the wristwatch case 1.

Here, a gap having substantially the same dimension as the width of the slit 16b in the separation section 16 is formed between the ends of the button head section 4b in the circumferential direction of the exterior case 8 and the inner surface of the button insertion hole 8a corresponding thereto. As a result, the push-button switches 4 are respectively attached to the 2 o'clock side and the 4 o'clock side of the wristwatch case 1. The rear cover 15 is attached to the lower portion of the wristwatch case 1, i.e., the lower portion of the first case section 10 so as to press and fix the timepiece module 5 into and to the wristwatch case 1. As a result, the wristwatch is assembled.

In the assembled wristwatch, when the exterior case 8 in the wristwatch case 1 is subjected to a shock due to a drop or the like, the exterior case 8 is displaced in the circumferential direction thereof in accordance with the strength of its shock force. That is, even though the exterior case 8 is formed of a high hardness material such as ceramics, the separation section 16 for separating the exterior case 8 in the circumferential direction thereof is provided in the portion where the switch section 3 on the 3 o'clock side is arranged, whereby the exterior case 8 can be displaced in the circumferential direction thereof by the separation section 16 when subjected to a shock due to a drop or the like.

That is, the separation section 16 in the exterior case 8 includes the slit 16b provided over the range from the upper end to the lower end positioned in the direction perpendicular to the circumferential direction of the exterior case 8, and the switch insertion hole 16c provided in the central portion of this slit 16b. Accordingly, when the exterior case 8 is subjected to a shock due to a drop or the like, the slit 16b and the switch insertion hole 16c in the separation section 16 can reliably and favorably displace the exterior case 8 in the circumferential direction thereof in accordance with the strength of the shock force.

Therefore, even if the exterior case 8 is subjected to a shock, generation of stress due to the shock can be dispersed, whereby the shock to which the exterior case 8 has been subjected can be mitigated. As a result, even if the exterior case 8 is subjected to a shock, the exterior case 8 can be prevented from being damaged. In this case, even if the exterior case 8 is displaced in the circumferential direction by being subjected to the shock, the band attachment section 2, the switch section 3, and the push-button switch 4 are prevented from being affected by the displacement in the circumferential direction of the exterior case 8.

That is, in the band attachment section 2, when the cover projection section 2b of the exterior case 8 covers the attachment projection section 2a of the first case section 10, a gap having substantially the same dimension as the width of the slit 16b in the separation section 16 in the exterior case 8 is formed in the circumferential direction of the exterior case 8 between the inner surface of the cover projection section 2b of the exterior case 8 and the outer surface of the attachment projection section 2a of the first case section 10.

As a result, even when the exterior case 8 is displaced in the circumferential direction by being subjected to a shock, the inner surface of the cover projection section 2b of the exterior case 8 and the outer surface of the attachment projection section 2a of the first case section 10 do not come in contact with each other. Accordingly, even if the exterior case 8 is subjected to a shock, the band attachment section 2 can be prevented from being damaged.

Also, in the switch section 3, a gap having substantially the same dimension as the width of the slit 16b in the separation section 16 in the exterior case 8 is formed in the circumferential direction of the exterior case 8 between the inner peripheral surface of the switch insertion hole 16c in the separation section 16 in the exterior case 8 and the outer peripheral surface of the operation head section 3b of the switch section 3. Accordingly, even if the exterior case 8 is displaced in the circumferential direction by being subjected to a shock, the inner peripheral surface of the switch insertion hole 16c in the exterior case 8 and the outer peripheral surface of the operation head section 3b of the switch section 3 do not come in contact with each other. Thus, even if the exterior case 8 is subjected to a shock, the switch section 3 can be prevented from being damaged.

Furthermore, the button insertion hole 8a in the exterior case 8 where the button head section 4b in the push-button switch 4 is arranged is formed to be longer in the circumferential direction of the exterior case 8 than the button head section 4b in the push-button switch 4. Accordingly, a gap having substantially the same dimension as the width of the slit 16b in the separation section 16 is formed between both ends of the button head section 4b in the circumferential direction of the exterior case 8 and both sides of the button insertion hole 8a corresponding thereto, in the circumferential direction of the exterior case 8.

As a result, even when the exterior case 8 is displaced in the circumferential direction by being subjected to a shock, both ends of the button head section 4b in the circumferential direction of the exterior case 8 and both sides of the button insertion hole 8a corresponding thereto can be prevented from coming in contact with each other. Accordingly, even if the exterior case 8 is subjected to a shock, the push-button switch 4 can be prevented from being damaged.

As such, this wristwatch includes the case body 7 and the exterior case 8 which is arranged on the outer periphery of the case body 7 and is provided with the separation section 16 for separating a part in the circumferential direction thereof of the case body 7. As a result, when the exterior case 8 is subjected to a shock due to a drop or the like, the exterior case 8 can be displaced in the circumferential direction thereof by the separation section 16. As a result, the shock can be mitigated, whereby the exterior case 8 can be prevented from being damaged by the shock.

That is, in this wristwatch, the exterior case 8 which is provided with the separation section 16 is arranged to be deformable in the circumferential direction on the outer periphery of the case body 7. As a result, when the exterior case 8 is subjected to a shock due to a drop or the like, the exterior case 8 can be displaced in the circumferential direction in accordance with the strength of the shock. Thus, generation of stress due to a shock in the exterior case 8 can be favorably dispersed. As a result, the shock can be favorably mitigated, whereby the exterior case 8 can be prevented from being damaged by the shock.

In this embodiment, the separation section 16 in the exterior case 8 is provided corresponding to the portion on the 3 o'clock side of the case body 7 on which the switch section 3 is provided. Accordingly, even though the separation section 16 is provided in the exterior case 8, by the case body 7 being provided with the switch section 3, the separation section 16 can be hidden not to be seen from the outside by the operation head section 3b of the switch section 3. As a result, even though the exterior case 8 is provided with the separation section 16, the outer appearance of the wristwatch case 1 is not degraded, whereby the design of the wristwatch case 1 can be enhanced.

Also, the separation section 16 includes the slit 16b for separating the exterior case 8 in the circumferential direction thereof and the switch insertion hole 16c which is provided in the central portion of the slit 16b and into which the operation head section 3b of the switch section 3 is inserted. As a result, when the exterior case 8 is subjected to a shock due to a drop or the like, the exterior case 8 can be reliably and favorably displaced in the circumferential direction thereof in response to its shock force by the slit 16b and the switch insertion hole 16c in the separation section 16 provided in the exterior case 8.

Also, the inner diameter of the switch insertion hole 16c is larger than the outer diameter of the operation head section 3b of the switch section 3. Accordingly, the operation head section 3b of the switch section 3 can be easily and favorably arranged within the switch insertion hole 16c while the operation head section 3b of the switch section 3 can be favorably exposed to the outside of the exterior case 8 from inside the switch insertion hole 16c. As a result, the operation head section 3b of the switch section 3 can be reliably and favorably operated.

Also, since the inner diameter of the switch insertion hole 16c is larger than the outer diameter of the operation head section 3b of the switch section 3, a gap having substantially the same dimension as the width of the slit 16b can be formed between the inner peripheral surface of the switch insertion hole 16c and the outer peripheral surface of the operation head section 3b of the switch section 3. Accordingly, even when the exterior case 8 is displaced in the circumferential direction by being subjected to a shock, the inner peripheral surface of the switch insertion hole 16c in the exterior case 8 and the outer peripheral surface of the operation head section 3b of the switch section 3 do not come in contact with each other. Thus, even if the exterior case 8 is subjected to a shock, the switch section 3 can be prevented from being damaged.

Also, in this wristwatch case 1, the case body 7 is provided with the push-button switch 4 that is a switch section other than the switch section 3. In addition, in the exterior case 8, the button insertion hole 8a, which is an attachment hole into which the button head section 4b in the push-button switch 4 is inserted, is formed to be longer in the circumferential direction of the exterior case 8 than the button head section 4b in the push-button switch 4. As a result, the button head section 4b in the push-button switch 4 can be easily and favorably arranged within the button insertion hole 8a and the button head section 4b in the push-button switch 4 can be reliably and favorably operated.

Furthermore, since the exterior case 8 has the button insertion hole 8a formed to be longer in the circumferential direction of the exterior case 8 than the button head section 4b in the push-button switch 4, a gap having substantially the same dimension as the width of the slit 16b can be formed between both ends of the button head section 4b in the circumferential direction of the exterior case 8 and both sides of the button insertion hole 8a corresponding thereto, in the circumferential direction of the exterior case 8. Accordingly, even when the exterior case 8 is displaced in the circumferential direction by being subjected to a shock, both ends of the button head section 4b and both sides of the button insertion hole 8a can be prevented from coming in contact with each other. Thus, even if the exterior case 8 is subjected to a shock, the push-button switch 4 can be prevented from being damaged.

Furthermore, in this wristwatch case 1, the band attachment section 2 includes the attachment projection section 2a of the first case section 10 and the cover projection section 2b of the exterior case 8 which covers this attachment projection section 2a. As a result, the cover projection section 2b can cover the attachment projection section 2a and, by this cover projection section 2b of the exterior case 8, the band attachment section 2 is not easily damaged. As a result, the design of the wristwatch case 1 can be enhanced.

Also, when the cover projection section 2b of the exterior case 8 covers the attachment projection section 2a of the first case section 10, a gap having substantially the same dimension as the width of the slit 16b in the exterior case 8 is formed in the circumferential direction of the exterior case 8 between the inner surface of the cover projection section 2b and the outer surface of the attachment projection section 2a. As a result, even when the exterior case 8 is displaced in the circumferential direction by being subjected to a shock, the inner surface of the cover projection section 2b of the exterior case 8 and the outer surface of the attachment projection section 2a of the first case section 10 do not come in contact with each other. Thus, even if the exterior case 8 is subjected to a shock, the band attachment section 2 can be prevented from being damaged.

Also, in this wristwatch case 1, the exterior case 8 is formed of ceramics such as zirconium oxide (ZrO₂) or aluminum oxide (Al₂O₃), whereby the hardness of the exterior case 8 can be increased. As a result, the surface of the exterior case 8 can be prevented from being easily damaged. Thus, the design of the wristwatch case 1 is excellent, and the quality thereof can be maintained.

In this embodiment, ceramics is a brittle material and therefore is easily damaged when subjected to a shock. However, when the exterior case 8 using this ceramics is subjected to a shock, the exterior case 8 is displaced in the circumferential direction thereof by the slit 16b and the switch insertion hole 16c in the separation section 16, so that the generation of stress due to the shock can be dispersed, and the shock can be mitigated. Thus, the exterior case 8 can be prevented from being damaged by the shock.

In the above-described embodiment, the separation section 16 is provided on the 3 o'clock side of the exterior case 8. However, the separation section 16 in the present invention is not necessarily required to be provided on the 3 o'clock side, and may be provided anywhere in the exterior case 8. Also, the separation section 16 is not required to be provided in one portion of the exterior case 8, and may be provided in a plurality of portions of the exterior case 8. For example, the separation section 16 may be further provided at a position on the 9 o'clock side opposite to the 3 o'clock side.

Also, in the above-described embodiment, the separation section 16 is structured to include the recess section 16a, the slit 16b, and the switch insertion hole 16c. However, the present invention is not limited thereto. For example, the separation section 16 may have a structure including only the slit 16b.

Moreover, in the above-described embodiment, the second case section 11 in the case body 7 is structured to include the outer case 12 and the inner case 13. However, the present invention is not limited thereto. For example, the second case section 11 may have a structure where the outer case 12 and the inner case 13 are integrally formed. Also, the case body 7 is not necessarily required to be constituted by the first case section 10 and the second case section 11, and may have a structure where the first case section 10 and the second case section 11 are integrally formed.

Furthermore, in the above-described embodiment, the present invention has been applied in a wristwatch. However, the present invention is not necessarily required to be applied in a wristwatch, and is applicable to various types of timepieces such as a travel watch, an alarm clock, a table clock, and a wall clock. In addition, the present invention is not necessarily required to be applied in a timepiece, and is applicable to respective cases of electronic devices such as a mobile phone and a personal digital assistant.

While the present invention has been described with reference to the preferred embodiments, it is intended that the invention be not limited by any of the details of the description therein but includes all the embodiments which fall within the scope of the appended claims.

What is claimed is:

1. A case comprising:
a case body; and
an exterior member which is arranged on an outer periphery of the case body in a manner to be deformable in a circumferential direction and which is provided with a separation section for separating at least a part of the case body in the circumferential direction.

2. The case according to claim 1, wherein the separation section of the exterior member is provided corresponding to a portion of the case body where a switch section is provided.

3. The case according to claim 2, wherein the separation section comprises a slit for separating the exterior member in the circumferential direction, and an insertion hole which is provided in a central portion of the slit and into which a head section of the switch section is inserted.

4. The case according to claim 3, wherein the insertion hole is formed having a length in the circumferential direction larger than an outer diameter of the head section of the switch section.

5. The case according to claim 2, wherein the case body is provided with an other switch section in addition to the switch section, and
wherein the exterior member is provided with an attachment hole into which a head section of the other switch section is inserted, and is formed such that a length of the attachment hole in the circumferential direction is larger than an outer diameter of the head section of the other switch section.

6. The case according to claim 3, wherein the case body is provided with an other switch section in addition to the switch section, and
the exterior member is provided with an attachment hole into which a head section of the other switch section is inserted, and is formed such that a length of the attachment hole in the circumferential direction is larger than an outer diameter of the head section of the other switch section.

7. The case according to claim 4, wherein the case body is provided with an other switch section in addition to the switch section, and
the exterior member is provided with an attachment hole into which a head section of the other switch section is inserted, and is formed such that a length of the attachment hole in the circumferential direction is larger than an outer diameter of the head section of the other switch section.

8. The case according to claim 1, wherein the case body has a band projection section provided protruding outward, and
wherein the exterior member is provided with a cover section which covers the band projection section and in which a gap positioned in the circumferential direction of the exterior member is formed between an inner surface of the cover section and an outer surface of the band projection section.

9. The case according to claim 2, wherein the case body has a band projection section provided protruding outward, and
wherein the exterior member is provided with a cover section which covers the band projection section and in which a gap positioned in the circumferential direction of the exterior member is formed between an inner surface of the cover section and an outer surface of the band projection section.

10. The case according to claim 3, wherein the case body has a band projection section provided protruding outward, and
wherein the exterior member is provided with a cover section which covers the band projection section and in which a gap positioned in the circumferential direction of the exterior member is formed between an inner surface of the cover section and an outer surface of the band projection section.

11. The case according to claim 4, wherein the case body has a band projection section provided protruding outward, and
wherein the exterior member is provided with a cover section which covers the band projection section and in which a gap positioned in the circumferential direction of the exterior member is formed between an inner surface of the cover section and an outer surface of the band projection section.

12. The case according to claim 5, wherein the case body has a band projection section provided protruding outward, and
wherein the exterior member is provided with a cover section which covers the band projection section and in which a gap positioned in the circumferential direction of the exterior member is formed between an inner surface of the cover section and an outer surface of the band projection section.

13. The case according to claim 6, wherein the case body has a band projection section provided protruding outward, and
wherein the exterior member is provided with a cover section which covers the band projection section and in which a gap positioned in the circumferential direction of the exterior member is formed between an inner surface of the cover section and an outer surface of the band projection section.

14. The case according to claim 7, wherein the case body has a band projection section provided protruding outward, and
wherein the exterior member is provided with a cover section which covers the band projection section and in which a gap positioned in the circumferential direction of the exterior member is formed between an inner surface of the cover section and an outer surface of the band projection section.

15. The case according to claim 1, wherein the exterior member is formed of ceramics.

16. The case according to claim 2, wherein the exterior member is formed of ceramics.

17. The case according to claim 3, wherein the exterior member is formed of ceramics.

18. A timepiece comprising the case according to claim 1.

19. A timepiece comprising the case according to claim 2.

20. A timepiece comprising the case according to claim 3.
